(19) United States
(12) Patent Application Publication
(10) Pub. No.: US 2004/0101385 A1
(43) Pub. Date: May 27, 2004

(54) Semiconductor process apparatus and SMIF pod used therein

(76) Inventors: Ta-Kuang Chang, Hsinchu (TW); Chin-Lung Wu, Tainan (TW); Tsang-Jung Lin, Hsinchu (TW); Lee-Zen Chen, Hsinchu (TW); Chin-Tsung Chen, Hsinchu (TW)

Correspondence Address: BIRCH STEWART KOLASCH & BIRCH, PO BOX 747, FALLS CHURCH, VA, 22040-0747, US

(21) Appl. No.: 10/302,924

(22) Filed: Nov. 25, 2002

(51) Int. Cl. B65G 1/00; B65H 1/00

(52) U.S. Cl. 414/217.1; 414/806; 414/935; 206/711; 206/710

(57) ABSTRACT

A semiconductor process apparatus and a SMIF pod used therein. The semiconductor process apparatus comprises a first support, a second support, and a SMIF pod. The first support includes a first pin and a first rotating device, and the first pin is rotated by the first rotating device in a first direction. The second support includes a second pin and a second rotating device, and the second pin is rotated by the second rotating device in a second direction opposite the first direction. The SMIF pod includes a base and a cover. The base includes a slot and an engaging member, and the cover defines a hole for the engaging member to be inserted into. The first pin is inserted into the slot when the SMIF pod is disposed on the first support, and the slot is rotated by the first pin in the first direction so that the engaging member is withdrawn from the hole. The second pin is inserted into the slot when the SMIF pod is disposed on the second support, such that the slot cannot be rotated the second pin in the second direction so that the engaging member cannot be withdrawn from the hole.

### BACKGROUND OF THE INVENTION

1. Field of the Invention

The invention relates to a semiconductor process apparatus; in particular, a semiconductor process apparatus with a SMIF pod that can be properly used in a restricted area.

2. Description of the Related Art

In a semiconductor process apparatus with a SMIF (standardized mechanical interface) pod, there is a restricted area for some processes. When a wafer enters the restricted area, it has to be put on a specific SMIF pod to avoid intermixing.

Referring to FIG. 1a, a conventional semiconductor process apparatus 10 includes several units 11, 12, 13, 14, 15 to conduct various processes respectively. These units 11, 12, 13, 14, 15 can be divided into two areas A, B, wherein area B is a restricted area. For example, the unit 14 provides a copper process, and the unit 15 provides an aluminium process. After a SMIF pod enters into area B from area A, it cannot enter into area A again, thus preventing contamination thereof.

Generally, a SMIF pod 20 is used to transfer the wafer in the semiconductor process apparatus 10. As shown in FIG. 1b, FIG. 1c, and FIG. 1d, the SMIF pod 20 includes a cover 21 and a base 22. The cover 21 defines a plurality of holes 21a. The base 22 includes a plurality of moveable members 22a and a plurality of engaging members 22b. The engaging members 22b can be rotated, and the moveable members 22a can be moved by the rotation of the engaging members 22b. To combine the cover 21 and the base 22, the moveable members 22a are firstly retracted into the base 21 by the rotation of the engaging members 22b. Then the cover 21 is placed on the base 22, and the moveable members 22a protrude from the base 21 by the rotation of the engaging members 22b to be inserted into the holes 21a of the cover 21. Thus, the cover 21 is combined with the base 22.

When the SMIF pod 20 is moved to one of the units 11, 12, 13, 14, 15, it is placed on a support 30 as shown in FIG. 1e. The support 30 includes two pins 31 and a rotating device 32 that can rotate the pins 31. After the SMIF pod 20 is placed on the support 30, the pins 31 are inserted into the slots of the engaging members 22b. Then, the pins 31 are rotated by the rotating device 32 to rotate the engaging members 22b so that the moveable members 22a are retracted into the base 22. Thus, the cover 21 is disengaged from the base 22, and the user can take out wafers inside the SMIF pod 20.

It is noted that before the wafers are moved to area B from area A, they are switched to the SMIF pod designed for area B from the SMIF pod designed for area A via a wafer switch device (not shown).

The conventional techniques to prevent intermixing between different areas are described as follows.

1. The SMIF pod is controlled by software to restrict its area. However, when the software is shut down, or loses power, or the setting of the software is incomplete, the SMIF pod cannot be properly restricted.

2. The various SMIF pods are separated by different colors to remind the user. However, when the user is tired or the light is insufficient, the user may misjudge the color of the SMIF pod and use the wrong SMIF pod.

3. The positions of the holes of the SMIF pod are changed so that the positions of the holes of the various SMIF pods are different. However, the modules for manufacturing the SMIF pod thus require redesign. Furthermore, the pins of the support for the SMIF pod to be placed thereon must be changed according to the corresponding hole. Thus, the cost is increased.

4. The number of the holes of the SMIF pod is reduced so that the number of the holes of the various SMIF pods is different. However, since the number of the holes of the SMIF pod is reduced, the number of the corresponding pins of the support is also reduced. Thus, the support may not support the SMIF pod properly.

5. The number of the holes of the SMIF pod is increased so that the number of the holes of the various SMIF pods is different. However, since the number of the holes of the SMIF pod is changed, the modules for manufacturing the SMIF pod are required to be redesigned. Furthermore, the number of the corresponding pins of the support must be changed according to the corresponding hole. Thus, the cost is increased.

### SUMMARY OF THE INVENTION

In order to address the disadvantages of the aforementioned semiconductor process apparatus, the invention provides a semiconductor process apparatus with a SMIF pod that can be properly used in a restricted area.

Another purpose of this invention is to provide a SMIF pod that can prevent intermixing.

Accordingly, the invention provides a semiconductor process apparatus. The semiconductor process apparatus comprises a first support, a second support, and a SMIF pod. The first support includes a first pin and a first rotating device, and the first pin is rotated by the first rotating device in a first direction. The second support includes a second pin and a second rotating device, and the second pin is rotated by the second rotating device in a second direction opposite the first direction. The SMIF pod includes a base and a cover. The base includes a slot and an engaging member, and the cover defines a hole for the engaging member to be inserted into. The first pin is inserted into the slot when the SMIF pod is disposed on the first support, and the slot is rotated by the first pin in the first direction so that the engaging member is withdrawn from the hole. The second pin is inserted into the slot when the SMIF pod is disposed on the second support, and the slot cannot be rotated by the second pin in the second direction so that the engaging member cannot be withdrawn from the hole.

In a preferred embodiment, the base further comprises a body, a rotating member, a first connecting member, and a second connecting member. The body includes the engaging member, and the engaging member is moveable in the body. The rotating member is disposed on the body in a rotatable manner. The slot is formed on the rotating member, and the rotating member is rotated by the first pin via the slot so that the engaging member is moved in the body. The first connecting member abuts the rotating member, and is disposed on the body in a moveable manner. The second connecting member is connected with the first connecting member and the engaging member respectively, and is disposed on the body in a moveable manner. Thus, the first connecting member is moved by the rotation of the rotating member so that the second connecting member is moved to move the engaging member in the body.

Furthermore, the rotating member includes a protrusion, and the first connecting member defines a concave portion corresponding to the protrusion.

The invention also provides a SMIF pod for a semiconductor process apparatus. This semiconductor process apparatus comprises a first support and a second support, and the first support includes a first pin rotated in a first direction, and the second support includes a second pin rotated in a second direction opposite the first direction. The SMIF pod comprises a base, and a cover. The base includes a slot and an engaging member. The cover is disposed on the base in a detachable manner, and defines a hole for the engaging member to be inserted into. The first pin is inserted into the slot when the base is disposed on the first support, and the slot is rotated by the first pin in the first direction so that the engaging member is withdrawn from the hole. The second pin is inserted into the slot when the base is disposed on the second support, and the slot cannot be rotated by the second pin in the second direction so that the engaging member cannot be withdrawn from the hole.

The invention also provides another semiconductor process apparatus. The semiconductor process apparatus comprises a first support, a second support, and a SMIF pod. The first support includes a first pin. The second support includes a second pin of a size different from that of the first pin. The SMIF pod includes a base and a cover. The base includes a slot and an engaging member, and the cover defines a hole for the engaging member to be inserted into. The first pin is inserted into the slot when the SMIF pod is disposed on the first support, and the slot is rotated by the first pin so that the engaging member is withdrawn from the hole. The second pin cannot be inserted into the slot when the SMIF pod is disposed on the second support so that the engaging member cannot be withdrawn from the hole.

The invention also provides another SMIF pod for a semiconductor process apparatus. The semiconductor process apparatus comprises a first support and a second support, and the first support includes a first pin, and the second support includes a second pin, of a size different from that of the first pin. The SMIF pod comprises a base and a cover. The base includes a slot and an engaging member. The cover is disposed on the base in a detachable manner, and defines a hole for the engaging member to be inserted into. The first pin is inserted into the slot when the base is disposed on the first support, and the slot is rotated by the first pin in the first direction so that the engaging member is withdrawn from the hole. The second pin cannot be inserted into the slot when the base is disposed on the second support so that the engaging member cannot be withdrawn from the hole.

### BRIEF DESCRIPTION OF THE DRAWINGS

The invention is hereinafter described in detail with reference to the accompanying drawings in which:

FIG. 1a is a schematic view of a conventional semiconductor process apparatus;

FIG. 1b is an exploded view of a conventional SMIF pod;

FIG. 1c is a schematic view of the combined SMIF pod in FIG. 1b;

FIG. 1d is a bottom view of the SMIF pod in FIG. 1c;

FIG. 1e is a schematic view of a conventional support;

FIG. 2a is a schematic view of a semiconductor process apparatus as disclosed in this invention;

FIG. 2b is a schematic view of a first support as disclosed in a first embodiment of this invention;

FIG. 2c is a schematic view of a second support as disclosed in a first embodiment of this invention;

FIG. 3a is an exploded view of a SMIF pod as disclosed in this invention;

FIG. 3b is a bottom view of the SMIF pod in FIG. 3a;

FIG. 4a is a schematic view that shows the SMIF pod as shown in FIG. 3a disposed on the first support as shown in FIG. 2b;

FIG. 4b is a schematic view that shows the SMIF pod as shown in FIG. 3a disposed on the second support as shown in FIG. 2c;

FIG. 5a is a schematic view of a first support as disclosed in a second embodiment of this invention;

FIG. 5b is a schematic view of a second support as disclosed in a second embodiment of this invention;

FIG. 6a is a schematic view that shows the SMIF pod as shown in FIG. 3a disposed on the first support as shown in FIG. 5a; and

FIG. 6b is a schematic view that shows the SMIF pod as shown in FIG. 3a disposed on the second support as shown in FIG. 5b.

### DETAILED DESCRIPTION OF THE INVENTION

First Embodiment

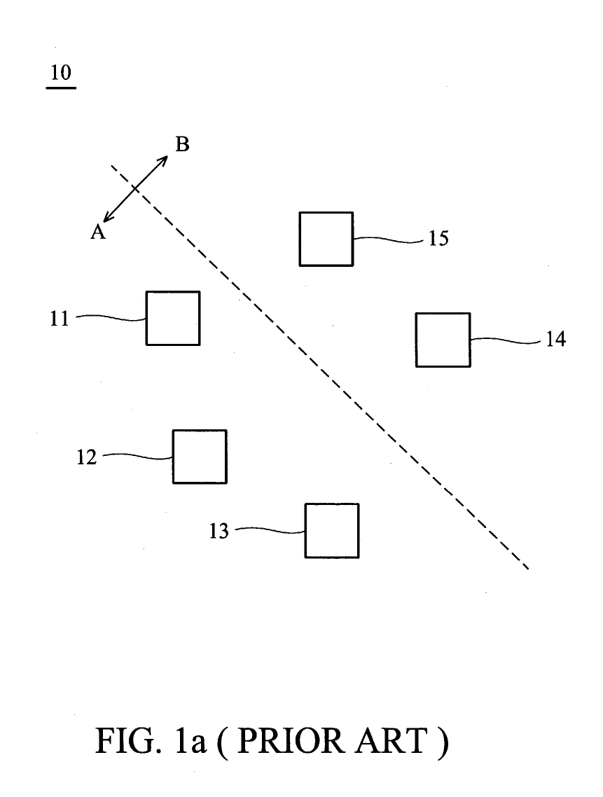

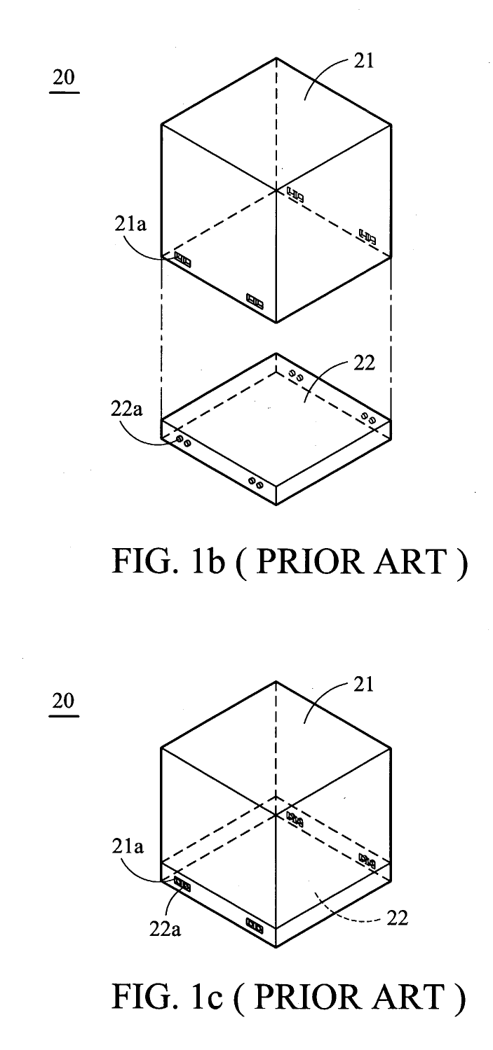

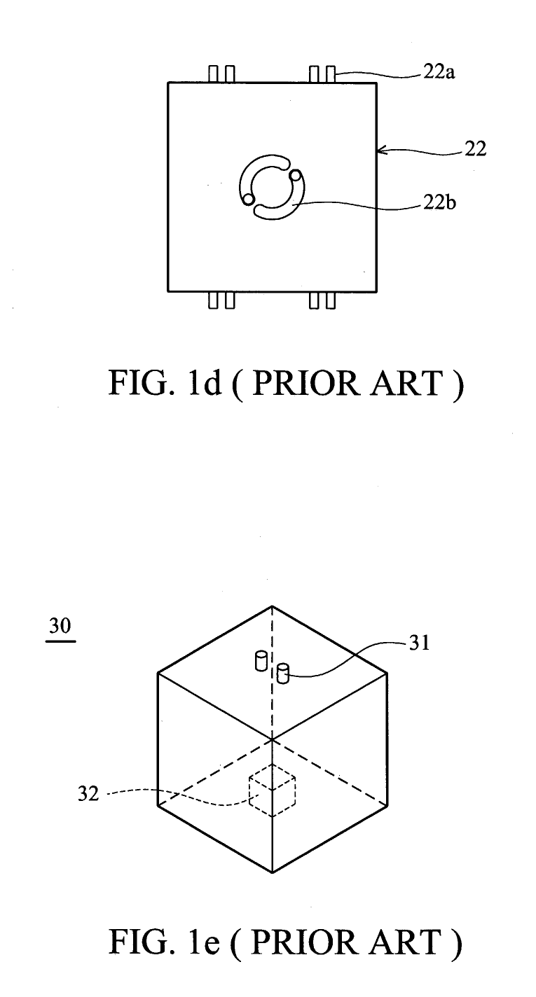

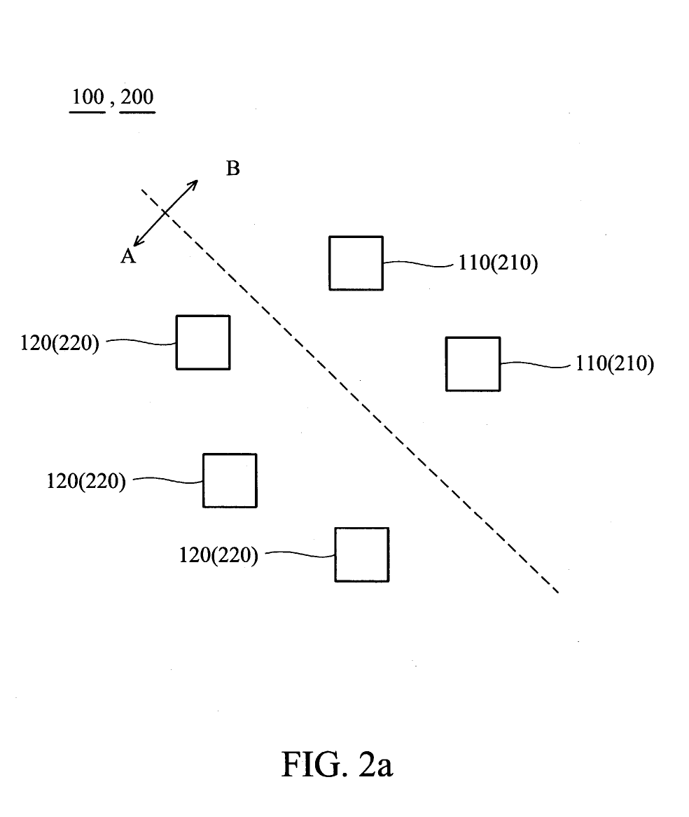

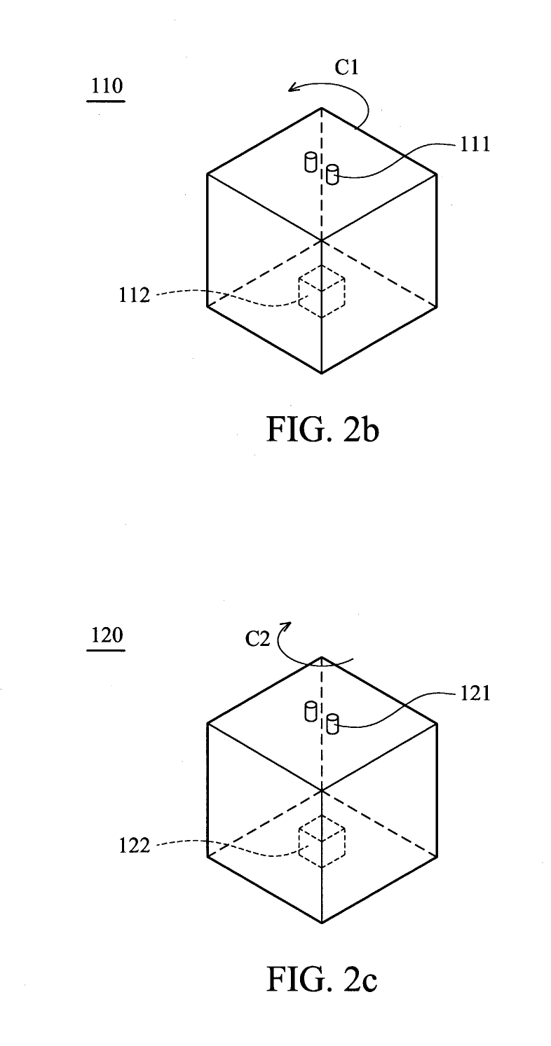

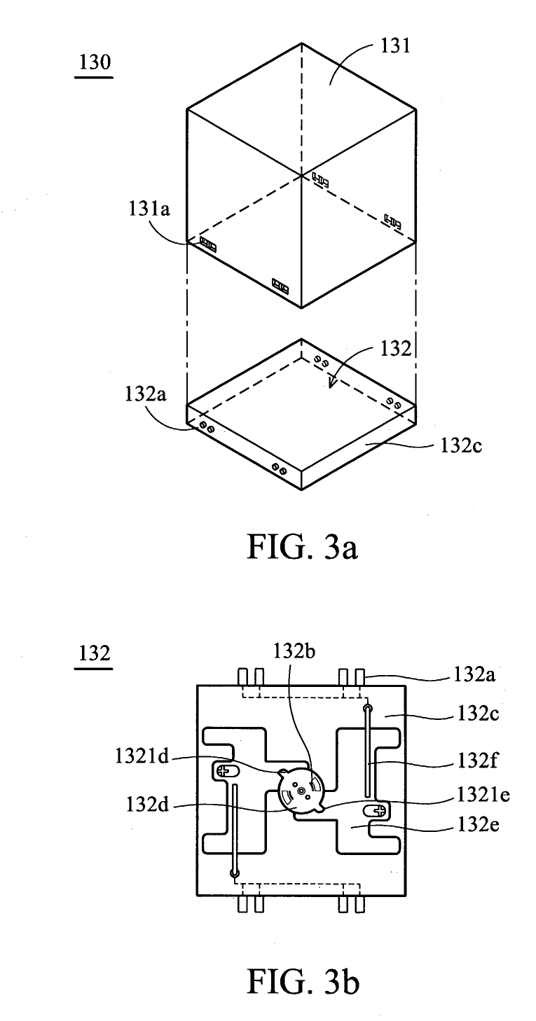

Referring to FIG. 2a and FIG. 3a, the invention provides a semiconductor process apparatus 100 and a SMIF pod 130. Like the conventional semiconductor process apparatus 10 shown in FIG. 1a, the semiconductor process apparatus 100 as disclosed in this invention includes several units to conduct various processes. These units can be divided into two areas A, B, wherein area B is a restricted area. The SMIF pod 130 as disclosed in this invention transfers wafers between units in area B. Each of the units in area B includes a first support 110 to support the SMIF pod 130 entering this unit. A normal SMIF pod (not shown) transfers wafers between units in area A. Each of the units in area A includes a second support 120 to support the normal SMIF pod entering this unit.

It is understood that the normal SMIF pod (not shown) for transferring wafers in area A is the conventional SMIF pod 20 as shown in FIG. 1c; therefore, its detailed description is omitted. Furthermore, it is also understood that before the wafers are moved to area B from area A, they are switched to the SMIF pod 130 from the normal SMIF pod via the conventional wafer switch device (not shown).

As shown in FIG. 2b, the first support 110 in area B includes two first pins 111 and a first rotating device 112. The first rotating device 112 is disposed in the first support 110, and is used to rotate the first pins 111 protruding form the surface of the first support 110 in a first direction C1. In FIG. 2b, the first direction C1 is counterclockwise. As shown in FIG. 2c, the second support 120 in area A includes two second pins 121 and a second rotating device 122. The second rotating device 122 is disposed in the second support 120, and is used to rotate the second pins 121 protruding form the surface of the second support 120 in a second direction C2 opposite the first direction C1. In FIG. 2c, the second direction C2 is clockwise.

Specifically, in this embodiment, the second support 120 in area A is the conventional support 30 as shown in FIG. 1e; that is, the structure of the second support 120 is the same as that of the support 30. The difference between the first support 110 and the second support 120 is that the rotating direction of the first rotating device 112 of the first support 110 is opposite that of the second rotating device 122 of the second support 120. Thus, when the SMIF pod 130 enters area A, the second support 120 cannot open the SMIF pod 130 due to the wrong rotating direction. As a result, the intermixing between different areas can be physically prevented. Furthermore, since only the rotating direction of the rotating device inside the support is changed, the outer appearance of the support remains the same. Thus, compared with the conventional support for avoiding the intermixing, the redesign of the first support has less impact on the whole unit of the semiconductor process apparatus.

As shown in FIG. 3a, the SMIF pod 130 in the units of area B includes a base 132 and a cover 131. The cover 131 defines a plurality of holes 131a.

Referring to FIG. 3b, the base 132 includes a body 132c, a rotating member 132d, two first connecting members 132e, and two second connecting members 132f. The body 132c is used as a basic element of the base 132, and includes a plurality of engaging members 132a therein. The engaging members 132a are disposed in the body 132c in a moveable manner. The rotating members 132d are disposed on the body 132c in a rotatable manner. Two slots 132b are formed on the rotating member 132b. The rotating member 132b also includes two protrusions 1321d at its periphery. The first connecting members 132e are disposed on the body 132c in a moveable manner. Each of the first connecting members 132e includes a concave portion 1321e corresponding to the protrusion 1321d to abut the rotating member 132d respectively. The second connecting members 132f are disposed on the body 132c in a moveable manner. Each of the second connecting members 132f is connected with the first connecting member 132e and the engaging member 132a respectively. Thus, when the rotating member 132d is rotated, the first connecting members 132e are moved by the rotating member 132d to move the second connecting members 132f so that the engaging members 132a are moved in the body 132c.

It is noted that part of the second connecting member 132f is disposed in the body 132c, and is illustrated by a dashed line. Furthermore, it is understood that an original position of the slots 132b on the base 132 of the SMIF pod 130 is different from that of the conventional SMIF pod 20. Thus, the rotating member 132d can simply be rotated in a direction opposite to the rotating direction of the engaging members of the conventional SMIF pod.

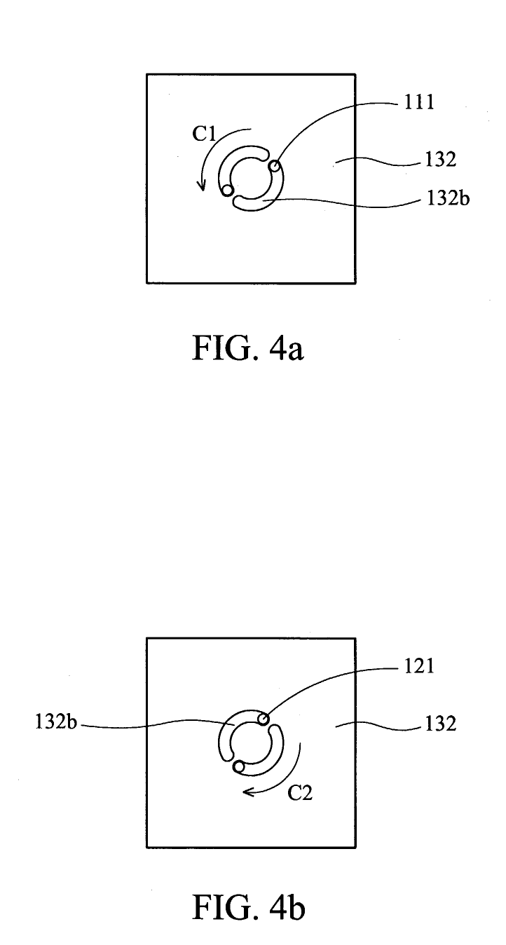

As stated above, when the SMIF pod 130 is disposed on the first support 110 in area B, the first pins 111 are inserted into the slot 132b of the base 132 of the SMIF pod 130 as shown in FIG. 4a. To separate the cover 131 from the base 132 to open the SMIF pod 130, the first pins 111 are rotated by the first rotating device 112 in the first direction C1. Then, the rotating member 132d is rotated by the first pins 111 through the slots 132b, and the engaging members 132a are moved into the body 132c by the rotating member 132d via the first connecting members 132e and the second connecting members 132f. Thus, the engaging members 132a are withdrawn from the holes 131a of the cover 131. As a result, the SMIF pod 130 is opened.

When the SMIF pod 130 is unexpectedly disposed on the second support 120 in area A, the second pins 121 are inserted into the slot 132b of the base 132 of the SMIF pod 130 as shown in FIG. 4b. However, since the second pins 121 cannot be rotated in the second direction C2, the rotating member 132d cannot be rotated through the slots 132b by the second pins 121. Thus, the second pins 121 are stuck by the rotating member 132d, and the engaging members 132a cannot be withdrawn from the holes 131a of the cover 131. That is, the SMIF pod 130 cannot be opened on the second support 120 in area A.

As stated above, the SMIF pod in the semiconductor process apparatus can be controlled properly in the restricted area. Thus, the units can be prevented from intermixing between different areas.

Furthermore, since only the rotating direction of the rotating device inside the first support 110 is changed, the outer appearance of the support remains the same. Thus, compared with the conventional support for avoiding the intermixing, the redesign of the first support 110 has less impact on the whole unit of the semiconductor process apparatus. It is noted that the position of the sensors relative to the rotation is also changed.

In addition, only the original position and the rotating direction of the slots 132b on the base 132 of the SMIF pod 130 are different from that of the conventional SMIF pod. Thus, the SMIF pod can be easily adjusted. As a result, compared with the conventional manner, the cost and the adjustment of the SMIF pod is reduced.

Second Embodiment

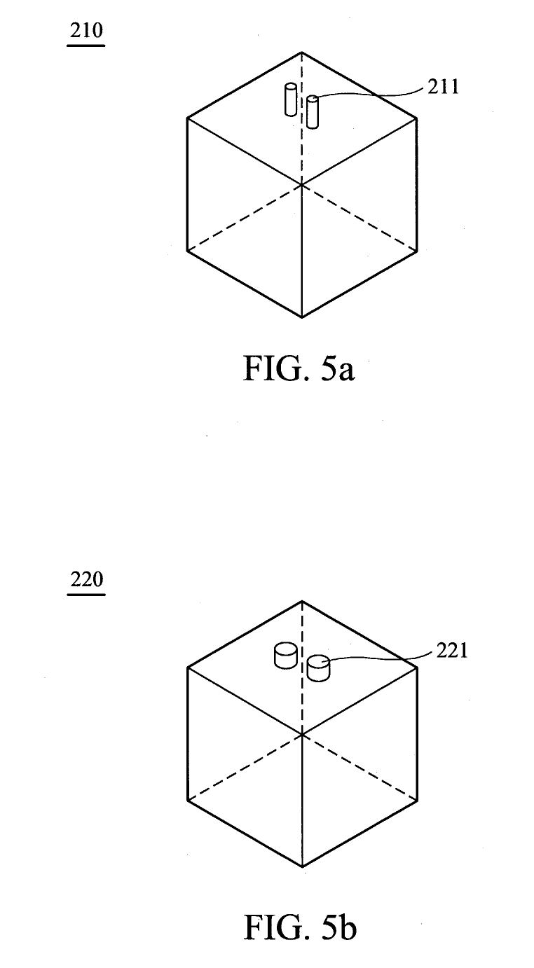

Referring to FIG. 2a, the invention provides another semiconductor process apparatus 200. Like the semiconductor process apparatus 100 in the first embodiment, the semiconductor process apparatus 200 as disclosed in this embodiment includes several units to conduct various processes. These units can be divided into two areas A, B, wherein area B is a restricted area. The SMIF pod 130 transfers wafers between units in area B. Each of the units in area B includes a first support 210, shown in FIG. 5a, to support the SMIF pod 130 entering this unit. A normal SMIF pod (not shown) transfers wafers between units in area A. Each of the units in area A includes a second support 220, shown in FIG. 5b, to support the normal SMIF pod (not shown) entering this unit.

It is understood that the normal SMIF pod (not shown) for transferring wafers in area A is the conventional SMIF pod 20 as shown in FIG. 1c; therefore, its detailed description is omitted. Furthermore, it is also understood that before the wafers are moved to area B from area A, they are switched to the SMIF pod 130 from the normal SMIF pod via the conventional wafer switch device (not shown).

As shown in FIG. 5a, the first support 210 in area B includes two first pins 211. As shown in FIG. 5b, the second support 220 in area A includes two second pins 221. The size of the second pins 221 is different from that of the first pins 211.

Specifically, in this embodiment, the second support 220 in area A is the conventional support 30 as shown in FIG. 1e; that is, the structure of the second support 220 is the same as that of the support 30. The difference between the first support 210 and the second support 220 is that the size of the first pins 211 is different from that of the second pins 221. Thus, when the SMIF pod 130 enters area A, the second support 220 cannot open the SMIF pod 130 due to the different sizes of the pins. As a result, intermixing between different areas can be physically prevented.

As shown in FIG. 3a, the SMIF pod 130 in the units of area B includes a base 132 and a cover 131. The cover 131 defines a plurality of holes 131a.

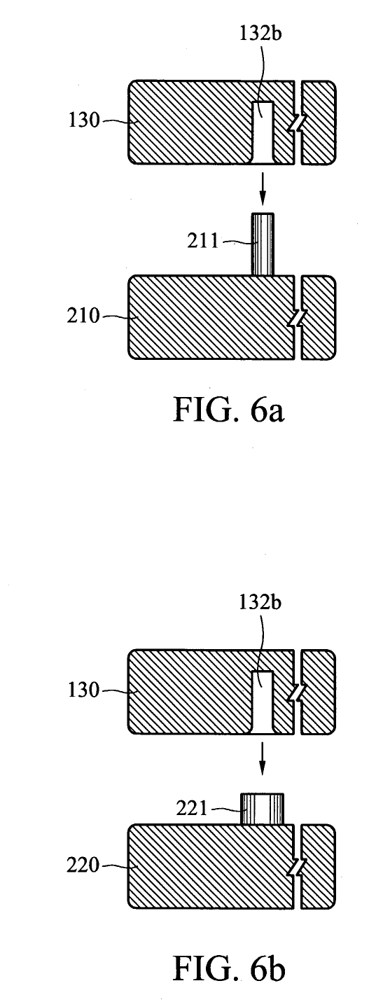

As stated above, when the SMIF pod 130 is disposed on the first support 210 in area B, the first pins 211 are inserted into the slot 132b of the base 132 of the SMIF pod 130 as shown in FIG. 6a. To separate the cover 131 from the base 132 to open the SMIF pod 130, the first pins 111 are rotated by the first rotating device 112. Then, the rotating member 132d is rotated by the first pins 111 through the slots 132b, and the engaging members 132a are moved into the body 132c by the rotating member 132d via the first connecting members 132e and the second connecting members 132f. Thus, the engaging members 132a are withdrawn from the holes 131a of the cover 131. As a result, the SMIF pod 130 is opened.

When the SMIF pod 130 is unexpectedly disposed on the second support 220 in area A, the second pins 221 cannot be inserted into the slot 132b of the base 132 of the SMIF pod 130 as shown in FIG. 6b. Thus, the rotating member 132d cannot be rotated through the slots 132b by the second pins 221. As a result, the engaging members 132a cannot be withdrawn from the holes 131a of the cover 131. That is, the SMIF pod 130 cannot be opened on the second support 220 in area A.

As stated above, the SMIF pod in the semiconductor process apparatus can be controlled properly in the restricted area. Thus, the units can be prevented from intermixing between different areas.

While the invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above, and all equivalents thereto.

What is claimed is:

1. A semiconductor process apparatus comprising:
a first support including a first pin and a first rotating device, wherein the first pin is rotated by the first rotating device in a first direction;
a second support including a second pin and a second rotating device, wherein the second pin is rotated by the second rotating device in a second direction opposite the first direction; and
a SMIF pod including a base and a cover, wherein the base includes a slot and an engaging member, and the cover defines a hole for the engaging member to be inserted into;
wherein the first pin is inserted into the slot when the SMIF pod is disposed on the first support, and the slot is rotated by the first pin in the first direction so that the engaging member is withdrawn from the hole;
wherein the second pin is inserted into the slot when the SMIF pod is disposed on the second support, such that the slot cannot be rotated by the second pin in the second direction so that the engaging member cannot be withdrawn from the hole.

2. The semiconductor process apparatus as claimed in claim 1, wherein the base further comprises:
a body including the engaging member, wherein the engaging member is moveable in the body; and
a rotating member disposed on the body in a rotatable manner, wherein the slot is formed on the rotating member, and the rotating member is rotated by the first pin via the slot so that the engaging member is moved in the body.

3. The semiconductor process apparatus as claimed in claim 2, wherein the base further comprises:
a first connecting member, abutting the rotating member, disposed on the body in a moveable manner; and
a second connecting member, connected with the first connecting member and the engaging member respectively, disposed on the body in a moveable manner, whereby the first connecting member is moved by the rotation of the rotating member so that the second connecting member is moved to move the engaging member in the body.

4. The semiconductor process apparatus as claimed in claim 2, wherein the rotating member includes a protrusion, and the first connecting member defines a concave portion corresponding to the protrusion.

5. A SMIF pod for a semiconductor process apparatus, wherein the semiconductor process apparatus comprises a first support and a second support, and the first support includes a first pin rotated in a first direction, and the second support includes a second pin rotated in a second direction opposite the first direction, and the SMIF pod comprises:
a base including a slot and an engaging member; and
a cover, disposed on the base in a detachable manner, defining a hole for the engaging member to be inserted into;
wherein the first pin is inserted into the slot when the base is disposed on the first support, and the slot is rotated by the first pin in the first direction so that the engaging member is withdrawn from the hole;
wherein the second pin is inserted into the slot when the base is disposed on the second support, such that the slot cannot be rotated by the second pin in the second direction so that the engaging member cannot be withdrawn from the hole.

6. The SMIF pod as claimed in claim 5, wherein the base further comprises:
a body including the engaging member, wherein the engaging member is moveable in the body; and
a rotating member disposed on the body in a rotatable manner, wherein the slot is formed on the rotating member, and the rotating member is rotated by the first pin via the slot so that the engaging member is moved in the body.

7. The SMIF pod as claimed in claim 6, wherein the base further comprises:
a first connecting member, abutting the rotating member, disposed on the body in a moveable manner; and
a second connecting member, connected with the first connecting member and the engaging member respectively, disposed on the body in a moveable manner, whereby the first connecting member is moved by the rotation of the rotating member so that the second connecting member is moved to move the engaging member in the body.

8. The SMIF pod as claimed in claim 6, wherein the rotating member includes a protrusion, and the first connecting member defines a concave portion corresponding to the protrusion.

9. A semiconductor process apparatus comprising:
a first support including a first pin;
a second support including a second pin, wherein the size of the second pin is different from that of the first pin; and
a SMIF pod including a base and a cover, wherein the base includes a slot and an engaging member, and the cover defines a hole for the engaging member to be inserted into;
wherein the first pin is inserted into the slot when the SMIF pod is disposed on the first support, and the slot is rotated by the first pin so that the engaging member is withdrawn from the hole;
wherein the second pin cannot be inserted into the slot when the SMIF pod is disposed on the second support so that the engaging member cannot be withdrawn from the hole.

10. The semiconductor process apparatus as claimed in claim 9, wherein the base further comprises:
a body including the engaging member, wherein the engaging member is moveable in the body; and
a rotating member disposed on the body in a rotatable manner, wherein the slot is formed on the rotating member, and the rotating member is rotated by the first pin via the slot so that the engaging member is moved in the body.

11. The semiconductor process apparatus as claimed in claim 10, wherein the base further comprises:
a first connecting member, abutting the rotating member, disposed on the body in a moveable manner; and
a second connecting member, connected with the first connecting member and the engaging member respectively, disposed on the body in a moveable manner, whereby the first connecting member is moved by the rotation of the rotating member so that the second connecting member is moved to move the engaging member in the body.

12. The semiconductor process apparatus as claimed in claim 10, wherein the rotating member includes a protrusion, and the first connecting member defines a concave portion corresponding to the protrusion.

13. A SMIF pod for a semiconductor process apparatus, wherein the semiconductor process apparatus comprises a first support and a second support, and the first support includes a first pin, and the second support includes a second pin, of a size different from that of the first pin, and the SMIF pod comprises:
a base including a slot and an engaging member; and
a cover, disposed on the base in a detachable manner, defining a hole for the engaging member to be inserted into;
wherein the first pin is inserted into the slot when the base is disposed on the first support, and the slot is rotated by the first pin so that the engaging member is withdrawn from the hole;
wherein the second pin cannot be inserted into the slot when the base is disposed on the second support so that the engaging member cannot be withdrawn from the hole.

14. The SMIF pod as claimed in claim 13, wherein the base further comprises:
a body including the engaging member, wherein the engaging member is moveable in the body; and
a rotating member disposed on the body in a rotatable manner, wherein the slot is formed on the rotating member, and the rotating member is rotated by the first pin via the slot so that the engaging member is moved in the body.

15. The SMIF pod as claimed in claim 14, wherein the base further comprises:
a first connecting member, abutting the rotating member, disposed on the body in a moveable manner; and
a second connecting member, connected with the first connecting member and the engaging member respectively, disposed on the body in a moveable manner, whereby the first connecting member is moved by the rotation of the rotating member so that the second connecting member is moved to move the engaging member in the body.

16. The SMIF pod as claimed in claim 14, wherein the rotating member includes a protrusion, and the first connecting member defines a concave portion corresponding to the protrusion.
